(19) United States
(12) Patent Application Publication
(10) Pub. No.: US 2024/0167431 A1
(43) Pub. Date: May 23, 2024

(54) A PISTON FOR A LEAN-BURN GASOLINE ENGINE

(71) Applicant: JAGUAR LAND ROVER LIMITED, Warwickshire (GB)

(72) Inventors: Jack JOHNSON, Whitley, Coventry, Warwickshire (GB); Lyn MCWILLIAM, Whitley, Coventry, Warwickshire (GB)

(21) Appl. No.: 18/551,628

(22) PCT Filed: Mar. 26, 2021
(86) PCT No.: PCT/EP2021/057913

§ 371 Date: Sep. 21, 2023

(51) Int. Cl. F02F 1/42; F02B 23/10; F02F 1/24

(52) U.S. Cl. CPC F02F 1/4214; F02F 1/242; F02B 2023/106; F02F 2001/241

(57) ABSTRACT

A piston for a lean-burn gasoline engine comprising a cylinder, an air inlet and an exhaust outlet, wherein the air inlet and the exhaust outlet are arranged about a longitudinal axis of the cylinder. The piston comprises a central axis which is aligned with the longitudinal axis of the cylinder. The working surface (79) of the piston (454) comprises a central dished portion and an outer sloped portion surrounded by an outer sloped portion. A first pair of valve pockets (444a, 444b) are located in the outer sloped portion on a first side of the dished portion, and a second pair of valve pockets (445a, 445b) located in the outer sloped portion on the second side of the dished portion. The dished portion comprises a ramp protuberance located between the first pair of valve pockets. The dished portion is configured to promote tumble of air flow into the cylinder from the air inlet, in use during an intake stroke of the piston.

### TECHNICAL FIELD

The present disclosure relates to a piston for a lean-burn gasoline engine, to a lean-burn gasoline engine comprising the piston and to a vehicle with such an engine.

### BACKGROUND

In classic internal combustion engines, gasoline burns best when it is mixed with air in proportions of about 14.7:1 (lambda=1) depending on the particular type of fuel. Most modern gasoline engines used in vehicles tend to operate at or near this so-called stoichiometric point for most of the time. Ideally, when burning fuel in an engine, only carbon dioxide (CO2) and water (H2O) are produced. In practice, the exhaust gas of an internal combustion engine also comprises significant amounts of carbon monoxide (CO), nitrogen oxides (NOx) and unburned hydrocarbons.

It is desirable to increase fuel efficiency and reduce unwanted emissions. One possible route for increasing fuel efficiency is to burn the fuel with an excess of air. Burning fuel in such an oxygen-rich environment is usually called lean-burning. Typical lean-burn engines may mix air and fuel in proportions of, for example, 20:1 (lambda>1.3) or even 30:1 (lambda>2).

Advantages of lean-burn engines include, for example, that they produce lower levels of CO2 and hydrocarbon emissions by better combustion control and more complete fuel burning inside the engine cylinders. The engines designed for lean burning can employ higher compression ratios and thus provide better performance, more efficient fuel use and lower exhaust hydrocarbon emissions than conventional gasoline engines. Additionally, lean-burn modes help to reduce throttling losses, which originate from the extra work that is required for pumping air through a partially closed throttle. When using more air to burn the fuel, the throttle can be kept more open when the demand for engine power is reduced.

Lean burning of fuel does, however, also come with some technical challenges that have to be overcome for providing an engine that is suitable and optimised for efficiently burning hydrocarbons in an oxygen-rich environment. For example, if the mixture is too lean, the engine may fail to combust. Especially at low loads and engine speeds, reduced flammability may affect the stability of the combustion process and introduce problems with engine knock. Further, a lower fuel concentration leads to less output. Because of such disadvantages, lean burn is currently only used for part of the engine map and most lean-burning modern engines, for example, tend to cruise and coast at or near the stoichiometric point.

In order to enable the lean burning of fuel over a larger portion of the engine map, the engine needs to be designed in such a way to enable a large airflow into the combustion chamber and to ensure a reliable combustion process that will effectively burn all fuel, despite the oxygen rich conditions.

It is an aim of the present invention to provide an improved gasoline engine.

### SUMMARY OF THE INVENTION

Aspects and embodiments of the invention provide a cylinder head for an engine, an engine, and a vehicle with such an engine. The engine may be suitable for use with fuels including gasoline, diesel, hydrogen, LPG or any other suitable combustible fuel. The engine may be a lean-burn engine.

According to an aspect of the present invention there is provided a piston for an engine comprising a cylinder, an air inlet and an exhaust outlet, wherein the air inlet and the exhaust outlet are arranged about a longitudinal axis of the cylinder, the piston comprising:
a circular peripheral wall having a central axis, wherein the peripheral wall is configured so that the central axis is substantially aligned with the longitudinal axis of the cylinder in use; and
a working surface comprising:
   a central dished portion;
   an outer sloped portion, wherein the outer sloped portion surrounds the central dished portion;
   a first pair of valve pockets located in the outer sloped portion on a first side of the central dished portion; and
a second pair of valve pockets located in the outer sloped portion on a second side of the central dished portion opposite the first side of the central dished portion,
wherein the central dished portion comprises a ramp protuberance located on the first side of the central dished portion between the first pair of valve pockets, and wherein the central dished portion is configured to promote tumble of air flow into the cylinder from the air inlet, in use during an intake stroke of the piston.

The piston described above is advantageous as increased tumble in the air flowing into the cylinder during the intake stroke of the piston, and during the first portion of the compression stroke. This improves the homogeneity of the air/fuel mixture leading to a more complete combustion of the fuel and consequently improved efficiency of the engine.

Optionally the central dished portion comprises a second ramp protuberance located on the second side of the central dished portion between the second pair of valve pockets. It is beneficial to tune the shape of the working surface of the piston so that air flow down the cylinder wall towards the piston is efficiently “caught” and airflow up the wall of the cylinder is efficiently “launched” back up the cylinder. The first and second protuberances help in this regard.

The central dished portion is optionally centred on the central axis of the piston such that the distance between the central axis of the piston and the intersection of the central dished portion with the outer sloped portion on the first side of the central dished portion is equal to the distance between the central axis of the piston and the intersection of the central dished portion with the outer sloped portion on the second side of the central dished portion.

The central dished portion may be offset from the central axis of the piston such that the distance between the central axis of the piston and the intersection of the central dished portion with the outer sloped portion on the first side of the central dished portion is not equal to the distance between the central axis of the piston and the intersection of the central dished portion with the outer sloped portion on the second side of the central dished portion.

It is beneficial to tune the position of the dished portion on the working surface so that air flow is efficiently “caught” and “launched” to better promote tumble.

In one example the surface of the central dished portion conforms to a portion of the surface of a sphere. Alternatively the surface of the central dished portion may conform to a portion of the surface of a prolate or oblate spheroid. Both of these shapes help to contain the tumble motion in the centre of the chamber so that when the flow breaks down into turbulence, it is centred around the spark plug and fuel injector.

The central dished portion optionally comprises a flat base portion surrounded by a curved wall portion for ease of manufacture with minimal impact on tumble performance.

The surface of the central dished portion is optionally asymmetrically curved about the central axis of the piston.

The piston may comprise a spark bowl located in the central dished portion.

In one example the outer sloped portion of the piston conforms to the surface of a cone.

In another aspect, the present invention provides an engine comprising a piston as described above.

The engine may comprise a cylinder head, wherein the cylinder head comprises:
a combustion chamber extending into the cylinder head, the combustion chamber comprising a combustion chamber roof surface having a sloped surface portion which is configured to conform to the outer sloped portion of the piston in use; and
a spark plug seat configured to support a spark plug at a predetermined position within the combustion chamber in use, wherein the combustion chamber is configured so that the apex of a geometric extension of the sloped surface portion of the combustion chamber roof surface is located within a volume envelope that is described by a 360° rotation of the spark plug when the spark plug is supported at the predetermined position in the combustion chamber by the spark plug seat.

This engine configuration promotes direction of the air and fuel mixture into the central portion of the combustion chamber, and towards the spark plug, as the piston approaches the sloped surface portions of the combustion chamber roof. This has been found to promote efficient burn of the air fuel mixture.

Optionally the gap between the sloped surface portion of the combustion chamber and the sloped outer portion of the piston is no less than 0.8 mm and no more than 1.4 mm when the piston is at top dead centre as measured when the engine is at substantially the same temperature as the environment.

In a further aspect the present invention provides a vehicle comprising an engine as described above.

In a still further aspect the present invention provides a cylinder head for an engine, the cylinder head comprising:
a combustion chamber extending into the cylinder head, the combustion chamber comprising a combustion chamber roof surface having a sloped surface portion; and
a spark plug seat configured to support a spark plug at a predetermined position within the combustion chamber in use, wherein the combustion chamber is configured so that the apex of a geometric extension of the sloped surface portion of the combustion chamber roof surface is located within a volume envelope that is described by a 360° rotation of the spark plug when the spark plug is supported at the predetermined position in the combustion chamber.

This arrangement promotes direction of the air and fuel mixture into the central domed portion of the combustion chamber, and towards the spark plug tip, as the piston of the engine approaches the sloped surface portions of the combustion chamber roof as it moves towards top dead centre. This has been found to promote efficient burn of the air fuel mixture.

Optionally the sloped surface portion of the combustion chamber roof conforms to part of the surface of a cone.

In another aspect the present invention provides an engine as described above.

In a further aspect the present invention provides a vehicle comprising an engine as described above.

### BRIEF DESCRIPTION OF THE DRAWINGS

One or more embodiments of the invention will now be described, by way of example only, with reference to the accompanying drawings, in which:

FIG. 1 shows a vehicle in which the invention may be used;

FIG. 2 shows a cross section of portion of an engine block and cylinder head with a piston according to the invention shown near bottom dead centre;

FIG. 3 shows a plan view of the roof surface of the combustion chamber of FIG. 2;

FIG. 4 shows a second cross section of the engine block and cylinder head of FIG. 2 with the piston near top dead centre;

FIG. 5 shows an isometric view of the working surface of the piston of FIG. 2;

FIG. 6 shows an isometric view of an alternative piston according to the invention;

FIG. 7 shows an isometric view of a further alternative piston according to the invention;

FIG. 8a shows an isometric view of a still further alternative piston according to the invention;

FIG. 8b shows a schematic drawing of the combustion chamber roof surface with the piston of FIG. 8a near top dead centre;

FIG. 9a shows an isometric view of a further alternative piston according to the invention;

FIG. 9b shows a schematic drawing of the combustion chamber roof surface with the piston of FIG. 9a near top dead centre;

FIG. 10a shows an isometric view of a still further alternative piston according to the invention; and

FIG. 10b shows a schematic drawing of the combustion chamber roof surface with the piston of FIG. 10a near top dead centre.

### DETAILED DESCRIPTION

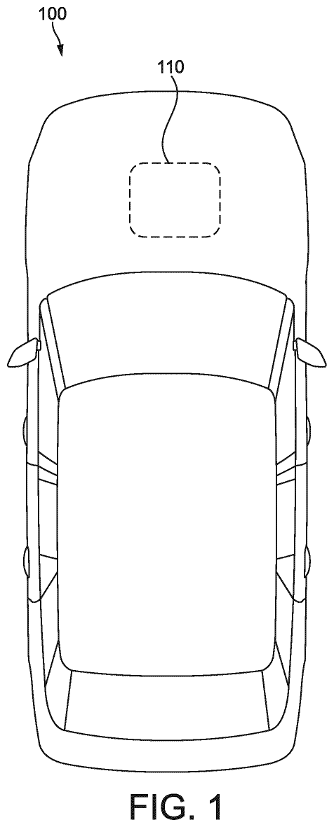

FIG. 1 shows a vehicle 100 in which the invention may be used. In this example, the vehicle 100 is a car, but the invention is equally applicable to other vehicles driven by a gasoline engine 110. In this vehicle 100, the gasoline engine 110 is positioned in the front and coupled to a drivetrain to drive the front and/or rear wheels of the vehicle 100. The energy needed for driving the vehicle 100 is provided by burning fuel in the engine's cylinders and let the cylinder pistons drive a crankshaft that is mechanically connected to the vehicle's drivetrain. The gasoline engine 110 may be a lean-burn gasoline engine.

Compared to classic internal combustion engines, lean-burn gasoline engines 110 burn the fuel with an excess of air in the air-fuel mixture. Typical lean-burn engines may mix air and fuel in proportions of, for example, 20:1 (lambda>1.3) or even 30:1 (lambda>2). Advantages of lean-burn engines include more efficient fuel use and lower exhaust hydrocarbon emissions than conventional gasoline engines.

In order to enable the lean burning of fuel over a large portion of the engine map, the engine 110 is designed in such a way to enable a large air flow into the combustion chamber and a good mixing with the relatively small amount of fuel that is to be burnt to ensure a reliable combustion process that will effectively burn all fuel, despite the oxygen rich conditions.

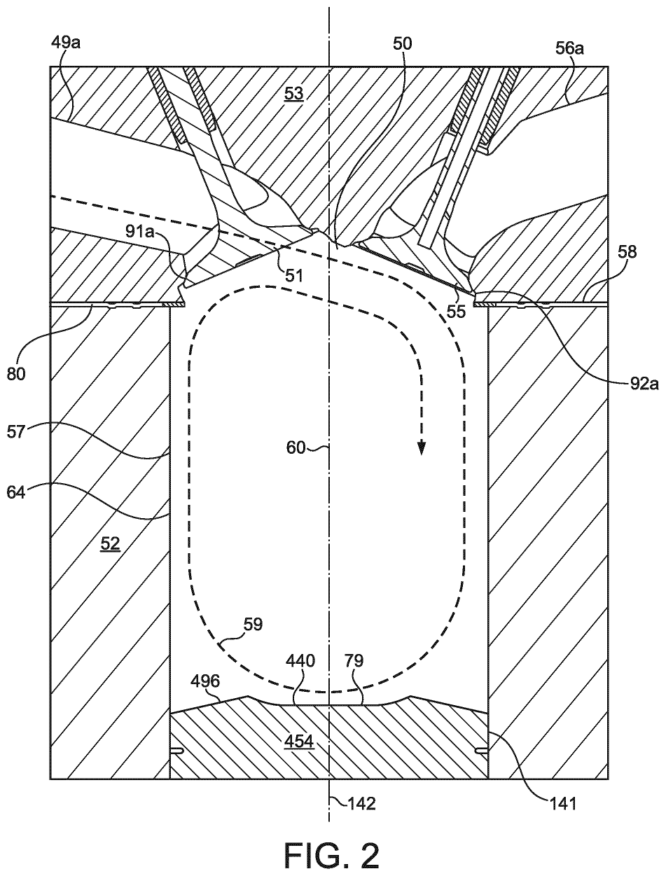

FIG. 2 shows a cross section of a portion of an engine block 52 and a cylinder head 53 of the engine 110. The engine block 52 comprises a cylinder 57 which houses a piston 454 shown near bottom dead centre (BDC) in FIG. 2. The cylinder is circular in cross-section in a plane perpendicular to the longitudinal axis 60 of the cylinder. The cylinder head 53 comprises a combustion chamber 50 which extends into the cylinder head 53 away from a gasket interface surface 58. A head gasket 80 is located between the engine block 52 and cylinder head 53.

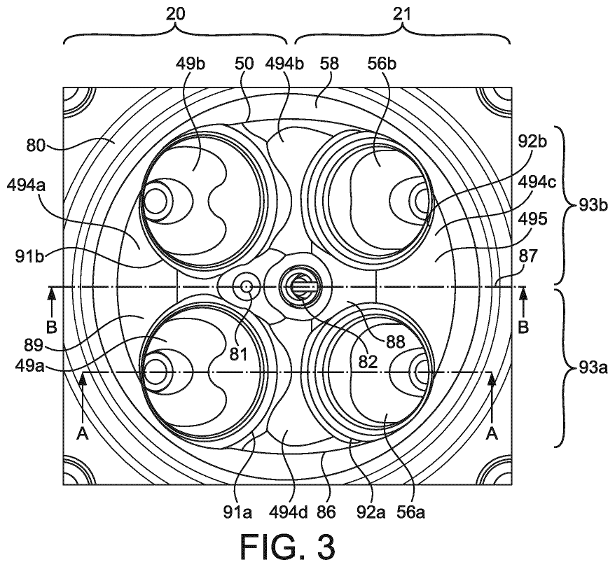

Referring to FIG. 3, a pair of air inlet passages 49a, 49b are located on an air inlet side 20 of the combustion chamber 50. The air inlet passages 49a, 49b provide a path for a flow of air to the combustion chamber 50 in use. A pair of exhaust outlet passages 56a, 56b are located on an exhaust outlet side 21 of the combustion chamber 50. The exhaust outlet passages 56a, 56b provide an exhaust path for the combustion products exiting the combustion chamber 50 in use. The air inlet passages 49a, 49b connect to respective air inlet openings 91a, 91b located in the roof surface 90 on the air inlet side 20 of the combustion chamber 50, and the exhaust outlet passages 56a, 56b connect to respective exhaust outlet openings 92a, 92b located in the roof surface 90 on the exhaust outlet side 21 of the combustion chamber 50. The first air inlet opening 91a and the first exhaust outlet opening 92a are located on a first side 93a of the combustion chamber 50, and the second air inlet opening 91b and the second exhaust outlet opening 92b are located on a second side 93b of the combustion chamber 50. The first 93a and second 93b sides of the combustion chamber 50 are located on either side of a plane of symmetry 87 of the combustion chamber 50. The cross section of FIG. 2 is taken along section A-A of FIG. 3 which passes through the first air inlet opening 91a and the first exhaust outlet opening 92a on the first side 93a of the combustion chamber 50.

Referring once again to FIG. 2, an inlet valve 51 controls the opening and closing of the first air inlet opening 91a, and an exhaust valve 55 controls the opening and closing of the first exhaust outlet opening 92a. An equivalent inlet valve (not shown) controls the opening and closing of the second air inlet opening 91b, and an equivalent exhaust valve (not shown) controls the opening and closing of the second exhaust outlet opening 92b. The inlet valve 51 and the exhaust valve 55 are shown in the closed position in FIG. 2.

A dotted line provides a simplified 2D representation of the preferred air flow path 59 into and through the combustion chamber 50 and cylinder 57 during the intake stroke of the piston 54. As noted above, the inlet valve 51 is shown in the closed position in FIG. 2. The air flow path 59 is not possible with the inlet valve 51 in the closed position as shown. Nonetheless, the preferred air flow path 59 is shown for the purpose of illustration.

As will be described in greater detail below, the design of the working surface 79 of the piston 454 helps to create a tumble motion of the incoming air, first along the roof 90 of the combustion chamber 50 towards the opposite wall of the cylinder 57, under the outlet valves 55 that close off the exhaust outlet openings 92a, 92b, and then down along that opposite wall of the cylinder 57, back over the working surface 79 of the piston 454 and up along the other wall of the cylinder 57 in the direction of the inlet valves 51 again. This tumble is preferably kept in motion during the full intake stroke and at least a portion of the compression stroke of the piston 454 moving through the cylinder 57. The thus produced tumble helps to obtain an optimal distribution of air and fuel inside the cylinder 57 and combustion chamber 50 that can then break down in the latter stages of the compression stroke into turbulence to facilitate the subsequent combustion process.

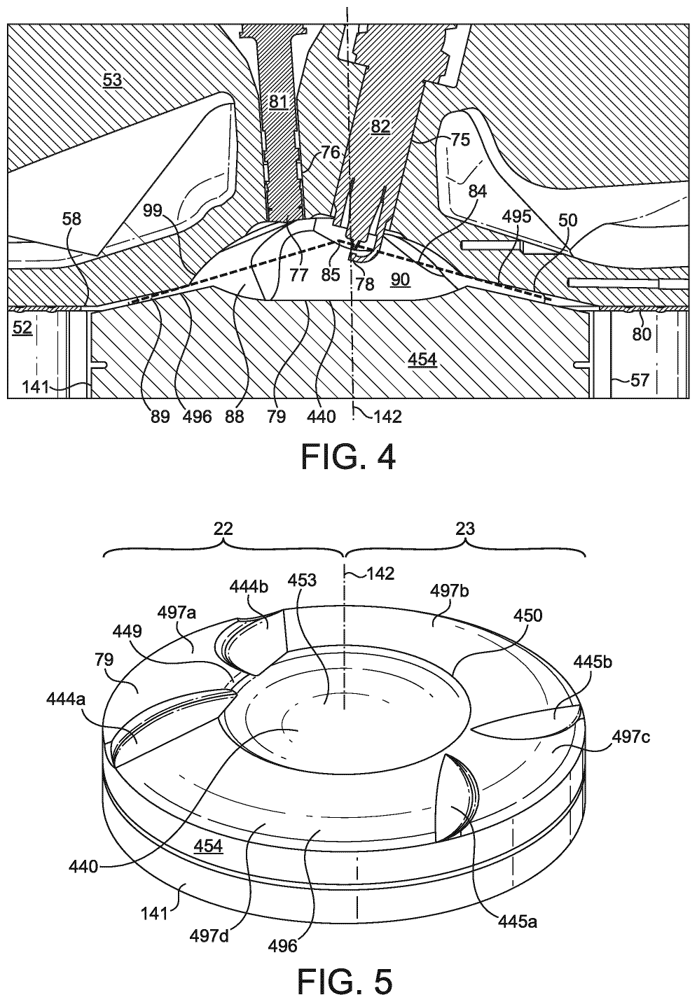

FIG. 3 shows a plan view of the roof surface 90 of the combustion chamber 50 and FIG. 4 shows a cross sectional view of the engine block 52 and cylinder head 53 along section B-B shown in FIG. 3. Section B-B corresponds with the plane of symmetry 87 of the combustion chamber 50 such that every feature on the first side 93a of the combustion chamber 50 is a mirror image of every feature of the second side 93b of the combustion chamber 50.

The combustion chamber roof surface 90 extends into the cylinder head 53 away from the gasket interface surface 58. The intersection between the combustion chamber roof surface 90 and the gasket interface surface 58 comprises a combustion chamber opening 86 in the gasket interface surface 58. The pair of air inlet openings 91a, 91b, and the pair of exhaust outlet openings 92a, 92b are formed in the combustion chamber roof surface 90. For the avoidance of doubt, the internal surfaces of the air inlet passages 49a, 49b, and exhaust outlet passages 56a, 56b seen in FIG. 3 do not form part of the combustion chamber roof surface 90. As best shown in FIG. 4, a central domed surface portion 99 of the combustion chamber roof surface 90 defines a central domed portion 88 of the combustion chamber 50. A sloped surface portion 495 of the combustion chamber roof surface 90 defines a sloped portion 89 of the combustion chamber 50. In this embodiment, the sloped surface portion 495 of the combustion chamber roof surface 90 comprises four sections 494a, 494b, 494c, 494d. The sloped surface portion 495—and therefore each of the four sections 494a, 494b, 494c, 494d of the sloped surface portion 495—has a shape which conforms to the surface of a single cone. That is to say, each of the four sections 494a, 494b, 494c, 494d of the sloped surface portion 495 form part of the surface of the same conical shape.

A spark plug 82 is located in a spark plug seat 75, and a fuel injector 81 is located in a fuel injector seat 76, both being located in the cylinder head 53 such that the tip 78 of the spark plug 82 and the tip 77 of the fuel injector 71 are located in the domed portion 88 of the combustion chamber 50. The spark plug seat 75 is configured to support the tip 78 of the spark plug 75 at a predetermined position within the combustion chamber.

FIG. 5 shows an isometric view of the working surface 79 of the piston 454. Referring to FIG. 4 and FIG. 5, the piston 454 comprises a circular peripheral wall 141 having a central axis 142 which is substantially aligned with the longitudinal axis 60 of the cylinder 57 (see FIG. 2) when the piston 454 is arranged for operation in the cylinder 57 of the engine 110.

The working surface 79 of the piston 454 comprises a central dished portion 440 which is surrounded by an outer sloped portion 496. The outer sloped portion 496 comprises four sections 497a, 497b, 497c, 497d. The outer sloped portion 496 of the working surface 79—and therefore each of the four sections 497a, 497b, 497c, 497d of the outer sloped portion 496—is configured to conform to the sloped surface portion 495 of the combustion chamber roof surface 90 when the piston 454 is installed for use in the cylinder 57. Therefore, in this embodiment, the outer sloped portion 496—and therefore each of the four sections 497a, 497b, 497c, 497d of the outer sloped portion 496, has a shape which conforms to the surface of a single cone. That is to say, each of the four sections 497a, 497b, 497c, 497d of the outer sloped portion 496 form part of the surface of the same conical shape.

The surface 453 of the central dished portion 440 has a shape which conforms to the surface of a sphere with its spherical axis of symmetry in line with the central axis 142 of the piston 454. The central dished portion 440 meets the outer sloped portion 496 at a chamfered edge 450. In this embodiment, the distance between the central axis 142 of the piston 454 and the intersection of the central dished portion 440 with the outer sloped portion 496 on the air inlet side 22 of the central dished portion 440 is equal to the distance between the central axis 142 of the piston 454 and the intersection of the central dished portion 440 with the outer sloped portion 496 on the exhaust outlet side 23 of the central dished portion 440.

Two valve pockets 444a, 444b are located in the outer sloped portion 496 of the working surface 79 on an air inlet side 22 of the piston 454, and two valve pockets 445a, 445b are located in the outer sloped portion 496 of the working surface 79 on an exhaust outlet side 23 of the piston 454. Each of the two valve pockets on the air inlet side and the two valve pockets on the exhaust outlet side may be referred to as pairs. These may be termed a first pair and a second pair. References to the air inlet side 22 and the exhaust outlet side 23 of the piston 454 refer to the orientation of the piston 54 when installed for use in the cylinder 57.

The valve pockets 444a, 444b provide room to accommodate the inlet valves 51 when they are open and the piston 454 is at or near top dead centre. Similarly, the valve pockets 445a, 445b provide room to accommodate the exhaust valves 55 when they are open and the piston 454 is at or near top dead centre. Because of the different sizes and swept volumes of the air inlet valves 51 as compared to the exhaust valves 55, the valve pockets 444a, 444b located in the outer sloped portion 496 on the air inlet side 22 overlap the central dished portion 440 to define a ramp protuberance 449 located between the valve pockets 444a, 444b. By contrast, the valve pockets 445a, 445b located in the outer sloped portion 496 on the exhaust outlet side 23 do not overlap the central dished portion 440 so that the section 497c of the outer sloped portion 496 is continuous with the neighbouring section 497b, 497d of the outer sloped portion 496.

As discussed above and illustrated in FIG. 2, during the intake stroke of the piston 454, and during the early stages of the compression stroke of the piston 454, the air flow path tumbles as illustrated by the dotted line 59. The profile of the central dished portion 440 helps to create this tumble by “catching” the air flow as it moves down the inner wall of the cylinder 57 on the exhaust outlet side 23 of the piston 454, and then by “launching” the air flow upward towards inner the inner wall of the cylinder 57 on the air inlet side 22 of the piston 454. It has been found in trials/computational fluid dynamic (CFD) modelling that increased tumble in the air flowing into the cylinder 57 during the intake stroke of the piston 454, and during the first portion of the compression stroke, improves the homogeneity of the air/fuel mixture leading to a more complete combustion of the fuel and consequently improved efficiency of the engine.

The ramp protuberance 449 maintains the efficacy of the tumble promoting nature of the central dished portion 440 despite the incursion into the central dished portion 440 by the valve pockets 444a, 444b.

Referring again to FIG. 4, the slope of the sloped surface portion 495 of the combustion chamber roof surface 90 is illustrated by dotted lines 84 which represent a geometric extension of the sloped surface portion 495. As discussed above, in this embodiment the sloped surface portion 495 has a shape which conforms to the surface of a cone. As can be seen in FIG. 4, the geometric extension 84 of the sloped surface portion 495 has its apex 85 located between the opening of the spark plug seat 75 in the combustion chamber roof 90 and the tip 78 of the spark plug 82.

During the intake stroke of the piston 454, and during the early stages of the compression stroke of the piston 454, the air flow path tumbles as illustrated by the dotted line 59 in FIG. 2. As the piston 454 moves through the later stages of the compression stroke this tumble airflow pattern breaks down into a turbulent flow which helps to maximise combustion efficiency and flame front speed. As the air and fuel mixture is compressed into the combustion chamber 50 by the rising piston 454, the air fuel mixture is forced into the central domed portion 88 of the combustion chamber 50 as the outer sloped portion 496 of the working surface 79 approaches the sloped surface portion 495 of the combustion chamber roof surface 90; this is known as “squish”. Because the sloped surface portion 495 of the combustion chamber roof surface 90 has its apex 85 located between the opening of the spark plug seat 75 in the combustion chamber roof 90 and the tip 78 of the spark plug 82, the air fuel mixture is directed towards the vicinity of the tip 78 of spark plug 82 where it is ignited by a spark just before the piston 454 reaches top dead centre.

The sloped surface portion 495 of the combustion chamber roof surface 90 and the outer sloped portion 496 of the working surface 79 of the piston 454 are configured so that the maximum separation between them when the piston 454 is at top dead centre is around 1.2 mm (measured normal to the surfaces when the engine is cold). It has been found in practice that the gap between the sloped surface portion 495 of the combustion chamber roof surface 90 and the outer sloped portion 496 of the working surface 79 should be greater than about 0.8 mm and less than about 1.4 mm when the piston 454 is at top dead centre (measured normal to the surfaces when the engine is cold). A gap of less than about 0.8 mm risks the piston 454 hitting the cylinder head 53, and a gap any greater than about 1.4 mm results in poor combustion and insufficient “squish”. The skilled person will understand that “cold” in the above description means substantially at the same temperature as the environment.

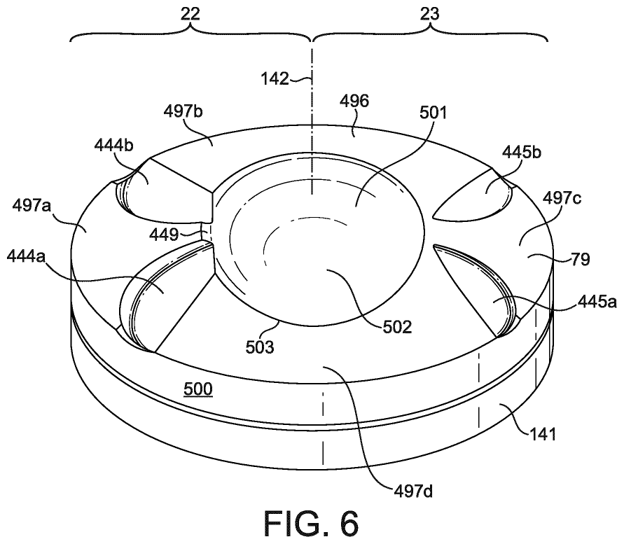

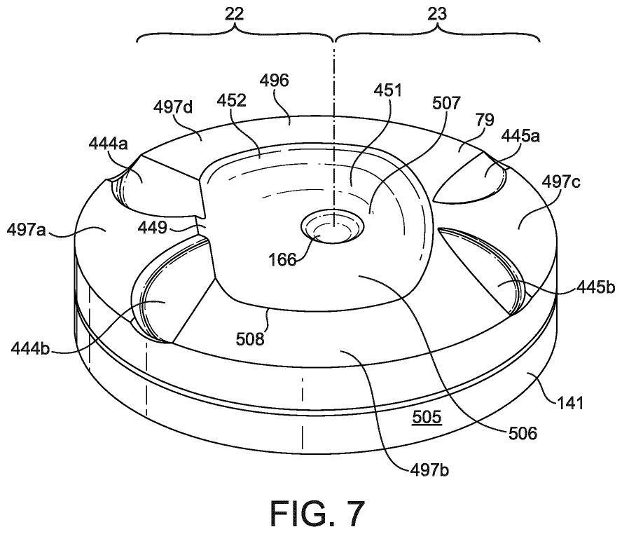

FIG. 6 and FIG. 7 show alternative pistons suitable for use in the engine 110 comprising the engine block 52 and the cylinder head 53. Like reference numerals have been used throughout to identify like components and features.

FIG. 6 shows an isometric view of the working surface 79 of an alternative piston 500. The piston 500 comprises a circular peripheral wall 141 having a central axis 142 which is substantially aligned with the longitudinal axis 60 of the cylinder 57 (see FIG. 2) when the piston 500 is arranged for operation in the cylinder 57 of the engine 110.

The working surface 79 of the piston 500 comprises a central dished portion 501 which is surrounded by an outer sloped portion 496. The outer sloped portion 496 comprises four sections 497a, 497b, 497c, 497d. The outer sloped portion 496 of the working surface 79—and therefore each of the four sections 497a, 497b, 497c, 497d of the outer sloped portion 496—is configured to conform to the sloped surface portion 495 of the combustion chamber roof surface 90 when the piston 500 is installed for use in the cylinder 57. Therefore, in this embodiment, the outer sloped portion 496—and therefore each of the four sections 497a, 497b, 497c, 497d of the outer sloped portion 496, has a shape which conforms to the surface of a single cone.

The surface 502 of the central dished portion 501 has a shape which conforms to the surface of a prolate spheroid such as a rugby ball shape. The surface 502 of the central dished portion 501 is centred about the central axis 142 of the piston 500 such that the distance between the edges 503 of the central dished portion 501 in a direction across the working surface 79 from a point on the edge 503 at the mid-point of the air intake side 22 to an opposing point on the edge 503 at the mid-point of the exhaust outlet side 23 is equally bisected by the central axis 142, and the distance between the points on the edge 503 which intersect a plane separating the piston 500 equally between the air inlet side 22 and the exhaust outlet side 23 is equally bisected by the central axis 142.

Two valve pockets 444a, 444b are located in the outer sloped portion 496 of the working surface 79 on an air inlet side 22 of the piston 500, and two valve pockets 445a, 445b are located in the outer sloped portion 496 of the working surface 79 on an exhaust outlet side 23 of the piston 500. The valve pockets 444a, 444b located in the outer sloped portion 496 on the air inlet side 22 overlap the central dished portion 501 to define a ramp protuberance 449 located between the valve pockets 444a, 444b. By contrast, the valve pockets 445a, 445b located in the outer sloped portion 496 on the exhaust outlet side 23 do not overlap the central dished portion 501 so that the section 497c of the outer sloped portion 496 is continuous with the neighbouring section 497b, 497d of the outer sloped portion 496.

FIG. 7 shows an isometric view of the working surface 79 of a further alternative piston 505. The piston 505 comprises a circular peripheral wall 141 having a central axis 142 which is substantially aligned with the longitudinal axis 60 of the cylinder 57 (see FIG. 2) when the piston 505 is arranged for operation in the cylinder 57 of the engine 110.

The working surface 79 of the piston 505 comprises a central dished portion 506 which is surrounded by an outer sloped portion 496. The outer sloped portion 496 comprises four sections 497a, 497b, 497c, 497d. The outer sloped portion 496 of the working surface 79—and therefore each of the four sections 497a, 497b, 497c, 497d of the outer sloped portion 496—is configured to conform to the sloped surface portion 495 of the combustion chamber roof surface 90 when the piston 505 is installed for use in the cylinder 57. Therefore, in this embodiment, the outer sloped portion 496—and therefore each of the four sections 497a, 497b, 497c, 497d of the outer sloped portion 496, has a shape which conforms to the surface of a single cone.

In this embodiment, the surface 507 of the central dished portion 506 comprises a spark bowl 166 which is located at the centre of the working surface 79 such that the central axis 142 of the piston 505 is located at the centre of the spark bowl 166. The surface 507 of the dished portion 506 is asymmetrical about the plane which separates the piston 505 equally between the air inlet side 22 and the exhaust outlet side 23 such that the distance between the edges 508 of the central dished portion 506 in a direction across the working surface 79 from a point on the edge 508 at the centre of the air intake side 22 to an opposing point on the edge 508 at the centre of the exhaust outlet side 23 is unequally bisected by the central axis 142. However, the surface 507 is symmetrical about a plane which passes through the central axis 142 of the piston 505 and which is perpendicular to the plane that separates the piston equally between the air inlet side 22 and the exhaust outlet side 23 such that the distance between the points on the edge 508 which intersects the plane separating the piston equally between the air inlet side 22 and the exhaust outlet side 23 is equally bisected by the central axis 142.

The base 451 of the surface 507 is substantially flat from the edges of the spark bowl 166 to a peripheral wall 452 which extends from the base 451 to the edges 508 of the dished portion 506. The peripheral wall 452 is curved with the degree of curvature varying about the central axis 142 of the piston 505 such that the peripheral wall is steepest at the mid-point of the air inlet side 22 of the piston 505 and shallowest along the plane separating the piston equally between the air inlet side 22 and the exhaust outlet side 23. The curvature of the peripheral wall 452 at the mid-point of the exhaust outlet side 23 being less than that of the point of the peripheral wall 452 at the opposing mid-point of the air inlet side 22, and greater than that of the peripheral wall 452 along the plane separating the piston equally between the air inlet side 22 and the exhaust outlet side 23. This configuration allows the working surface 79 of the piston 505 to be tuned to promote the tumble of the air flow in the cylinder 57. Preferably, the curvature of the peripheral wall 452 at the mid-point of the air inlet side 22 of the piston 505 is chosen so that the air flow is “launched” towards a mid-point 64 of the cylinder 57 (see FIG. 2) when the piston 505 is at or near BDC. This maximises the tumble vortex and limits “dead zones” where there might be poor air/fuel mixing. The curvature of the peripheral wall 452 at the mid-point of the exhaust outlet side 23 of the piston 505 is chosen so that the air flow is “caught” as it moves down the wall of the cylinder 57 towards the piston 505.

Two valve pockets 444a, 444b are located in the outer sloped portion 496 of the working surface 79 on an air inlet side 22 of the piston 505, and two valve pockets 445a, 445b are located in the outer sloped portion 496 of the working surface 79 on an exhaust outlet side 23 of the piston 505. The valve pockets 444a, 444b located in the outer sloped portion 496 on the air inlet side 22 overlap the central dished portion 506 to define a ramp protuberance 449 located between the valve pockets 444a, 444b. By contrast, the valve pockets 445a, 445b located in the outer sloped portion 496 on the exhaust outlet side 23 do not overlap the central dished portion 506 so that the section 497c of the outer sloped portion 496 is continuous with the neighbouring section 497b, 497d of the outer sloped portion 496.

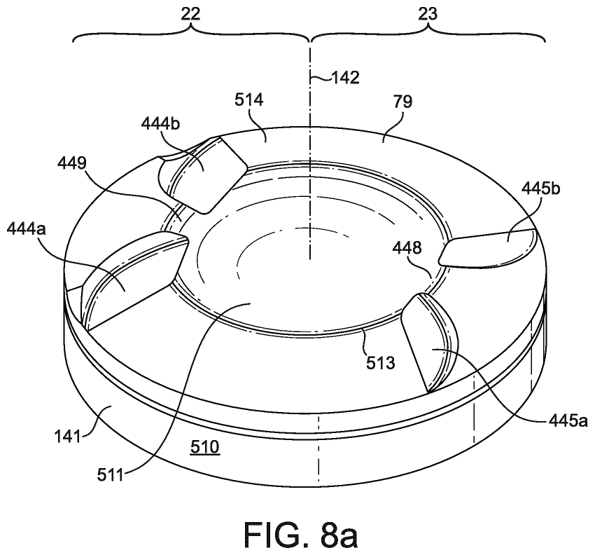

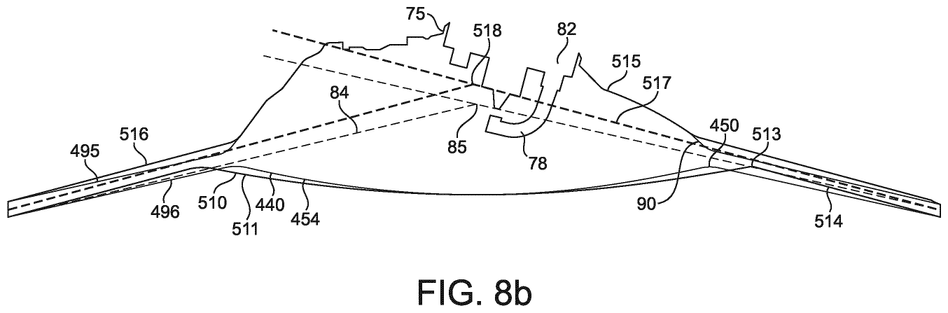

FIG. 8a shows an isometric view of a still further alternative piston 510 and FIG. 8b shows a schematic drawing of the combustion chamber roof surface with the pistons of FIGS. 5 and 8a near top dead centre. The piston 510 of FIG. 8a is similar in all respects to the piston 454 of FIG. 5 except that the central dished portion 511 of the working surface 79 is wider than that of the piston 454 of FIG. 5. As a result, the valve pockets 445a, 445b on the exhaust outlet side 23 of the piston 510 overlap the central dished portion 511 to define a second ramp protuberance 448 located between the valve pockets 445a, 445b.

As best shown in FIG. 8b, the piston 510 of FIG. 8a has a wider central dished portion 511 than the central dished portion 440 of the piston 454 of FIG. 5 such that the edge 513 of the central dished portion 511 is further towards the circular peripheral wall 141 of the piston 510 than the edge 450 of the central dished portion 440 of the piston 454 of FIG. 5. As a result, in order to maintain the minimum gap of between 0.8 mm and 1.4 mm between the sloped surface portion of the combustion chamber roof surface and the outer sloped portion of the working surface of the piston, the slope of the outer sloped portion 514 of the working surface 79 of the piston 510 is steeper than the outer sloped portion 496 of the working surface 79 of the piston 454 of FIG. 5. Consequently, the sloped surface portion 516 of the combustion chamber roof surface 515, which is configured to conform to the outer sloped portion 514 of the working surface 79 of the piston 510, is steeper than the sloped surface portion 495 of the combustion chamber roof surface 90 which is configured to conform to the outer sloped portion 476 of the working surface 79 of the piston 454. As a result, the geometric extension 517 of the sloped surface portion 516 of the combustion chamber roof surface 515 has its apex 518 at a different position to the apex 85 of the geometric extension 84 of the sloped surface portion 495 of the combustion chamber roof surface 90. Nonetheless, the apex 518 is still located between the opening of the spark plug seat 75 in the combustion chamber roof 515 and the tip 78 of the spark plug 82 so that the air fuel mixture is directed towards the vicinity of the tip 78 of spark plug 82 where it is ignited by a spark just before the piston 510 reaches top dead centre.

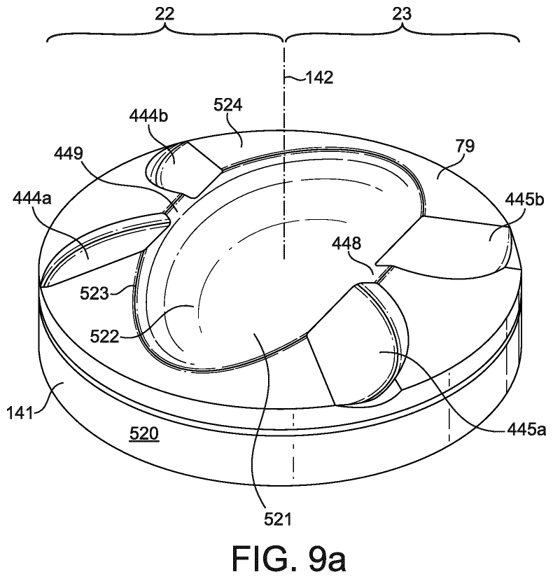

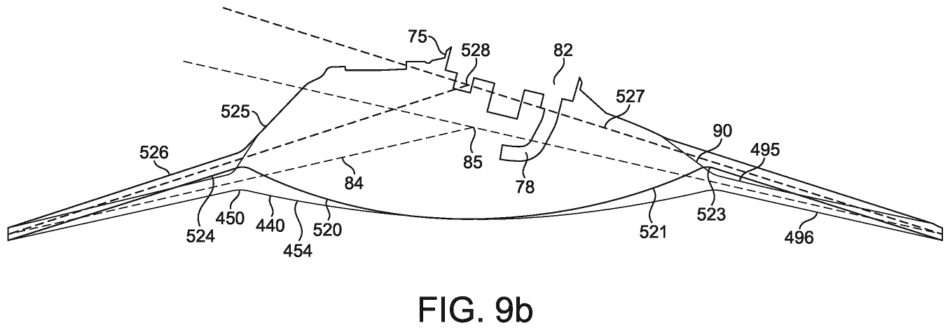

FIG. 9a shows an isometric view of a still further alternative piston 520 and FIG. 9b shows a schematic drawing of the combustion chamber roof surface with the pistons of FIGS. 5 and 9a near top dead centre. The piston 520 of FIG. 9a is similar in all respects to the piston 454 of FIG. 5 except that the surface 522 of the central dished portion 521 has an elongated curved shape centred about the central axis 142 of the piston 520 such that the distance between the edges 523 of the central dished portion 521 in a direction across the working surface 79 from a point on the edge 523 at the mid-point of the air intake side 22 to an opposing point on the edge 523 at the mid-point of the exhaust outlet side 23 is equally bisected by the central axis 142, and the distance between the points on the edge 523 which intersect a plane separating the piston 520 equally between the air inlet side 22 and the exhaust outlet side 23 is equally bisected by the central axis 142.

As best shown in FIG. 9b, the central dished portion 521 of the piston 520 is substantially the same width as the central dished portion 440 of the piston 454 of FIG. 5. However, the edge 523 of central dished portion 521 is higher at the mid-points of the air inlet 22 and exhaust outlet 23 sides than the edge 450 of the central dished portion 440 of the piston 454. As a result, the valve pockets 445a, 445b on the exhaust outlet side 23 of the piston 520 overlap the central dished portion 521 to define a second ramp protuberance 448 located between the valve pockets 445a, 445b.

In order to maintain the minimum gap of between 0.8 mm and 1.4 mm between the sloped surface portion of the combustion chamber roof surface and the outer sloped portion of the working surface of the piston, the slope of the outer sloped portion 524 of the working surface 79 of the piston 520 is steeper than the outer sloped portion 496 of the working surface 79 of the piston 454. Consequently, the sloped surface portion 526 of the combustion chamber roof surface 525, which is configured to conform to the outer sloped portion 524 of the working surface 79 of the piston 520, is steeper than the sloped surface portion 495 of the combustion chamber roof surface 90 which is configured to conform to the outer sloped portion 476 of the working surface 79 of the piston 454. As a result, the geometric extension 527 of the sloped surface portion 526 of the combustion chamber roof surface 525 has its apex 528 at a different position to the apex 85 of the geometric extension 84 of the sloped surface portion 495 of the combustion chamber roof surface 90. Nonetheless, the apex 528 is still located between the opening of the spark plug seat 75 in the combustion chamber roof 525 and the tip 78 of the spark plug 82 so that the air fuel mixture is directed towards the vicinity of the tip 78 of spark plug 82 where it is ignited by a spark just before the piston 520 reaches top dead centre.

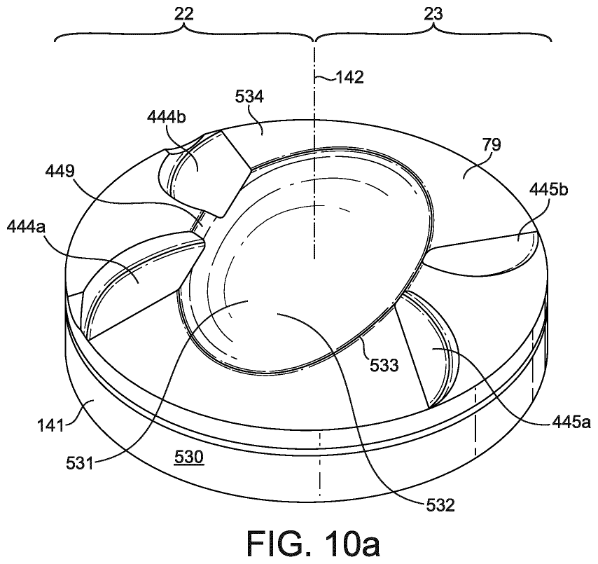

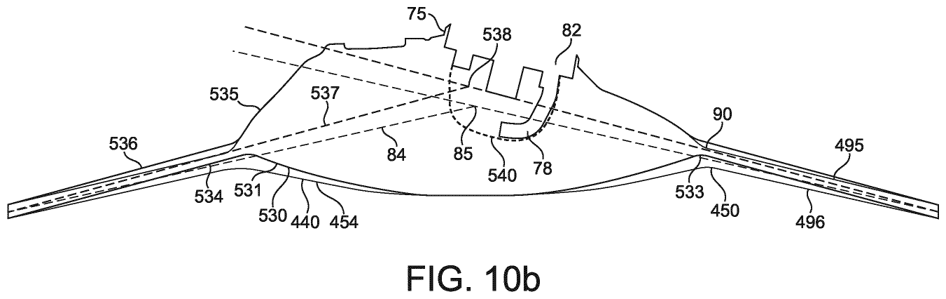

FIG. 10a shows an isometric view of a still further alternative piston 530 and FIG. 10b shows a schematic drawing of the combustion chamber roof surface with the pistons of FIGS. 5 and 10a near top dead centre. The piston 530 of FIG. 10a is similar in all respects to the piston 454 of FIG. 5 except that the surface 532 of the central dished portion 531 conforms to the shape of a prolate spheroid centred about the central axis 142 of the piston 530.

As best shown in FIG. 10b, the central dished portion 531 of the piston 530 is narrower than the width of the central dished portion 440 of the piston 454 of FIG. 5, and the edge 533 of central dished portion 521 is higher at the mid-points of the air inlet 22 and exhaust outlet 23 sides than the edge 450 of the central dished portion 440 of the piston 454. As a result, the valve pockets 445a, 445b on the exhaust outlet side 23 of the piston 530 adjoin the central dished portion 531.

In order to maintain the minimum gap of between 0.8 mm and 1.4 mm between the sloped surface portion of the combustion chamber roof surface and the outer sloped portion of the working surface of the piston, the slope of the outer sloped portion 534 of the working surface 79 of the piston 530 is steeper than the outer sloped portion 496 of the working surface 79 of the piston 454. Consequently, the sloped surface portion 536 of the combustion chamber roof surface 535, which is configured to conform to the outer sloped portion 534 of the working surface 79 of the piston 530, is steeper than the sloped surface portion 495 of the combustion chamber roof surface 90 which is configured to conform to the outer sloped portion 476 of the working surface 79 of the piston 454. As a result, the geometric extension 537 of the sloped surface portion 536 of the combustion chamber roof surface 535 has its apex 538 at a different position to the apex 85 of the geometric extension 84 of the sloped surface portion 495 of the combustion chamber roof surface 90. Nonetheless, the apex 538 is still located between the opening of the spark plug seat 75 in the combustion chamber roof 535 and the tip 78 of the spark plug 82 so that the air fuel mixture is directed towards the vicinity of the tip 78 of spark plug 82 where it is ignited by a spark just before the piston 530 reaches top dead centre.

As will be clear to a person skilled in the art, there are many possible configurations for a piston having a central dished portion surrounded by an outer sloped portion and each particular engine geometry and fuel combination will require slightly different tuning of the working surface configuration and associated combustion chamber roof geometry. It has been found n practice that it is desirable for the “squish” to be aimed at the lower end of the spark plug in use. As demonstrated by the pistons described above, it is possible to aim the “squish at slightly different positions in the space below the spark plug. It is preferable to aim the “squish” so that the apex of a geometric extension of the sloped surface portion of the combustion chamber roof surface is located within a volume envelope that is described by a 360° rotation of the spark plug 82 when the spark plug 82 is supported by the spark plug seat 76 in the combustion chamber 50. This envelope illustrated in FIG. 10b by dotted line 540. It will be clear to the skilled person that the spark plug 82 does not actually rotate in its seat 76 in use, but rather is held in a predetermined position. However, the skilled person will understand that nonetheless, a notional 360° rotation of the spark plug 82 when the spark plug 82 is held at the predetermined position in the combustion chamber 50 will describe a defined volume.

In the embodiments described above the outer sloped portions 496, 514, 524, 534 of the pistons have all conformed to the shape of a single cone such that the geometric extensions 84, 517, 527, 537 of the sloped portions 496, 514, 524, 534 all have a common apex. In an alternative embodiment the outer sloped portion of the piston may have sections which conform to different cones which may share a common apex or which may have different apex locations. In such cases the apex of the geometric extensions of the different conforming conical surfaces of the combustion chamber roof are nonetheless located within the volume 540 described by a 360° rotation of the spark plug 82.

In a further alternative the outer sloped portion of the piston may comprise planar facets. In such cases, the geometric extensions of the different conforming flat surfaces of the combustion chamber roof are aimed at volume 540 described by a 360° rotation of the spark plug 82.

It will be understood that the different configurations of the working surface 79 of the pistons 454, 50, 505, 510, 520, 530 described above are examples only and that may different configurations are possible, In particular, it will be understood that the dished surface portions may be centrally located about the central axis 142 of the piston or may be off set from centre, may be symmetrical or asymmetrical, may have a flat or curved base, and may comprise a spark bowl.

Although the spark plug 82 and fuel injector 81 are shown in line along the plane of symmetry 87 of the combustion chamber 50, it will be appreciated that the spark plug 82 and fuel injector 81 may in other embodiments be located sided by side in a plane perpendicular to the plane of symmetry 87 or in any other suitable position.

It will be appreciated that various changes and modifications can be made to the present invention without departing from the scope of the present application.

1-18. (canceled)

19. A piston for a lean-burn gasoline engine comprising a cylinder, an air inlet and an exhaust outlet, wherein the air inlet and the exhaust outlet are arranged about a longitudinal axis of the cylinder, the piston comprising:
a circular peripheral wall having a central axis, wherein the peripheral wall is configured so that the central axis is substantially aligned with the longitudinal axis of the cylinder in use; and
a working surface comprising:
a central dished portion;
an outer sloped portion, wherein the outer sloped portion surrounds the central dished portion;
a first pair of valve pockets located in the outer sloped portion on a first side of the central dished portion; and
a second pair of valve pockets located in the outer sloped portion on a second side of the central dished portion opposite the first side of the central dished portion,
wherein the central dished portion comprises a ramp protuberance located on the first side of the central dished portion between the first pair of valve pockets, and wherein the central dished portion is configured to promote tumble of air flow into the cylinder from the air inlet, in use during an intake stroke of the piston.

20. A piston as claimed in claim 19, wherein the central dished portion comprises a second ramp protuberance located on the second side of the central dished portion between the second pair of valve pockets.

21. A piston as claimed in claim 20, wherein the central dished portion is centered on the central axis of the piston such that the distance between the central axis of the piston and the intersection of the central dished portion with the outer sloped portion on the first side of the central dished portion is equal to the distance between the central axis of the piston and the intersection of the central dished portion with the outer sloped portion on the second side of the central dished portion.

22. A piston as claimed in claim 20, wherein the central dished portion is offset from the central axis of the piston such that the distance between the central axis of the piston and the intersection of the central dished portion with the outer sloped portion on the first side of the central dished portion is not equal to the distance between the central axis of the piston and the intersection of the central dished portion with the outer sloped portion on the second side of the central dished portion.

23. A piston as claimed in claim 19, wherein the surface of the central dished portion conforms to a portion of the surface of a sphere.

24. A piston as claimed in claim 19, wherein the surface of the central dished portion conforms to a portion of the surface of a prolate or oblate spheroid.

25. A piston as claimed in claim 19, wherein the central dished portion comprises a flat base portion surrounded by a curved wall portion.

26. A piston as claimed in claim 19, wherein the surface of the central dished portion is asymmetrically curved about the central axis of the piston.

27. A piston as claimed in claim 19, comprising a spark bowl located in the central dished portion.

28. A piston as claimed in claim 19, wherein the outer sloped portion of the piston conforms to the surface of a cone.

29. A lean-burn gasoline engine comprising a piston as claimed in claim 19.

30. A lean-burn gasoline engine as claimed in claim 29, comprising a cylinder head, wherein the cylinder head comprises:
a combustion chamber extending into the cylinder head, the combustion chamber comprising a combustion chamber roof surface having a sloped surface portion which is configured to conform to the outer sloped portion of the piston in use; and
a spark plug seat configured to support a spark plug at a predetermined position within the combustion chamber in use, wherein the combustion chamber is configured so that the apex of a geometric extension of the sloped surface portion of the combustion chamber roof surface is located within a volume envelope that is described by a 360° rotation of the spark plug when the spark plug is supported at the predetermined position in the combustion chamber by the spark plug seat.

31. A lean-burn gasoline engine as claimed in claim 30, wherein the gap between the sloped surface portion of the combustion chamber and the sloped outer portion of the piston is no less than 0.8 mm and no more than 1.4 mm when the piston is at top dead centre as measured when the engine is at substantially the same temperature as the environment.

32. A vehicle comprising a lean-burn gasoline engine according to claim 29.

33. A cylinder head for a lean-burn gasoline engine, the cylinder head comprising:
a combustion chamber extending into the cylinder head, the combustion chamber comprising a combustion chamber roof surface having a sloped surface portion; and
a spark plug seat configured to support a spark plug at a predetermined position within the combustion chamber in use, wherein the combustion chamber is configured so that the apex of a geometric extension of the sloped surface portion of the combustion chamber roof surface is located within a volume envelope that is described by a 360° rotation of the spark plug when the spark plug is supported at the predetermined position in the combustion chamber.

34. A cylinder head as claimed in claim 33, wherein the sloped surface portion of the combustion chamber roof conforms to part of the surface of a cone.

35. A lean-burn gasoline engine comprising a cylinder head as claimed in claim 34.

36. A vehicle comprising a lean-burn gasoline engine as claimed in claim 35.
